(19) United States
(12) Patent Application Publication
(10) Pub. No.: US 2026/0208776 A1
(43) Pub. Date: Jul. 23, 2026

(54) SYSTEM AND METHOD FOR INTERACTIVE OPERATION OF REAL TRAIN AND SIMULATION TRAIN

(71) Applicant: CASCO SIGNAL LTD., Shanghai (CN)

(72) Inventors: Liang GUO, Shanghai (CN); Tao WANG, Shanghai (CN); Jinyu YUE, Shanghai (CN); Yifeng RAN, Shanghai (CN); Yu FAN, Shanghai (CN); Yan YAN, Shanghai (CN); Yuan GUO, Shanghai (CN); Yibo FU, Shanghai (CN)

(73) Assignee: CASCO SIGNAL LTD., Shanghai (CN)

(21) Appl. No.: 19/139,007

(22) PCT Filed: Nov. 28, 2023
(86) PCT No.: PCT/CN2023/134699

§ 371 Date: Jun. 13, 2025

(30) Foreign Application Priority Data
Dec. 21, 2022 (CN) 202211650364.5

(51) Int. Cl. B61L 27/37; B61L 27/10; B61L 27/40; B61L 27/60

(52) U.S. Cl. CPC B61L 27/37; B61L 27/10; B61L 27/40; B61L 27/60

(57) ABSTRACT

A system and method for interactive operation of a real train and a simulation train. A real system includes one or more real trains, one or more real tracks, a real trackside device, and a real signal system which controls the one or more real trains on the one or more real tracks. A simulation system includes one or more simulation trains and a trackside simulation system which has one or more simulation stations, one or more simulation tracks, and a simulation trackside device corresponding to the real system. An interface unit synchronizes train operation information of the one or more real trains and the one or more simulation trains in real time in the real signal system and a trackside signal system. The trackside simulation system controls, based on location information of the one or more real trains, the one or more simulation trains to be added. The real signal system sends a corresponding movement authority for the one or more real trains and the one or more simulation trains, to achieve the interactive operation of the one or more real trains and the one or more simulation trains.

### TECHNICAL FIELD

The present disclosure relates to the technical field of rail transit simulation, and in particular, to a system and method for interactive operation of a real train and a simulation train.

### BACKGROUND

Before a signal system or train operation control system, especially a newly developed signal system or train operation control system, is put into service, indoor simulation tests and pilot line (or trial line) operation tests are usually carried out to verify the functions and performance thereof, wherein a multi-train tracking test is a very important phase and part.

When the multi-train tracking test is carried out on the pilot line, generally only one to two real trains can operate due to the cost and the limitations of line conditions of most pilot lines. To achieve the objective of the multi-train tracking test, a corresponding track section is occupied and cleared in a manual manner or in a manner of controlling a track circuit relay by a simple timing control apparatus, so as to simulate the operation situations of other trains except a real train, thereby achieving the test objective.

However, it is often difficult to accurately simulate the operation performance and behaviors of a real train and an on-board control system in the above method, and a good test effect cannot be achieved. Furthermore, for a system, such as a CTCS-N train control system, in which physical means (i.e. track circuits or axle counters) are employed to detect train occupancy, the above traditional method cannot completely meet the requirements of the multi-train tracking test in such system.

In addition, in the process of constructing training bases and practice lines, constrained by sites and conditions, also require the interactive operation between a real train and a simulation train to reduce construction costs.

### SUMMARY

An objective of the present disclosure is to provide a system for interactive operation of a real train and a simulation train, so that the operation performance of the real train can be accurately simulated, thereby achieving the interactive operation of the real train and the simulation train in a real system and a simulation system, meeting the requirements of a pilot line for carrying out a multi-train tracking test on trains, and facilitating the test of safety performance of a new train operation control system.

To achieve the above objective, the present disclosure provides a system for interactive operation of a real train and a simulation train, including: a real system, a simulation system, and an interface unit, wherein the real system includes: one or more real trains, one or more real tracks, a real trackside device, and
a real signal system; and the real signal system is used for controlling the one or more real trains to normally travel on the one or more real tracks;
the simulation system is implemented by software, and includes: one or more simulation trains and a trackside simulation system; the trackside simulation system has one or more simulation stations, one or more simulation tracks, and a simulation trackside device corresponding to the real system; and the one or more simulation trains operates on the one or more simulation tracks; and
the interface unit synchronizes train operation information of the one or more real trains and the one or more simulation trains in real time in the real signal system and a trackside signal system, and the train operation information includes: location information, route information, an occupied or cleared status of one or more track sections, and a signal display status; the trackside simulation system controls, based on the location information of the one or more real trains, the one or more simulation trains to be added on the one or more simulation tracks; and the real signal system calculates and sends a corresponding movement authority for the one or more real trains and the one or more simulation trains, to achieve the interactive operation of the one or more real trains and the one or more simulation trains in the real system and the simulation system.

Optionally, the real trackside device includes one or more of a signal, a track circuit, a switch machine, an axle counter, and a balise.

Optionally, the real signal system includes: a central centralized traffic control (CTC), a station CTC, an interlocking system, a station train control system, and a central train control system;
the central CTC issues traffic schedules of the one or more real trains and the one or more simulation train to the station CTC;
the station CTC automatically generates a route control instruction according to the traffic schedules and sends the route control instruction to the interlocking system;
the interlocking system controls the real trackside device based on the route control instruction to complete automatic arrangement of routes;
the central train control system implements, based on a temporary speed restriction command sent by the central CTC, digital coding on the track circuit and generation and selection of a message of the balise; and
a station train control center is used for sending the message to the balise, and the message includes: receiving route information, temporary speed restriction information, and home signal degraded indication.

Optionally, the one or more real trains is provided with an on-board train control system, and the on-board train control system includes: an automatic train protection and/or an automatic train operation; and the one or more simulation trains is provided with a simulation on-board train control system, and the simulation on-board train control system has same functions as the on-board train control system.

Optionally, the real trackside device further includes a wireless communication system which is in wireless signal connection between the central train control system and the on-board train control system and is used for wirelessly sending the message to the on-board train control system.

Optionally, in a CTCS level 2 or lower level real signal system, the movement authority of the one or more real trains is from track circuit code sending and/or signal indication in the real system, and the track circuit code sending and/or the signal indication is synchronized to the trackside simulation system for performing movement authority on the one or more simulation trains; and in a CTCS level 3 or higher level real signal system or any other type of communication based train control system, the movement authority of both the one or more simulation trains and the one or more real trains is from the central train control system in the real system.

Optionally, the interface unit includes a hardware interface unit; the hardware interface unit includes a first interface unit and a second interface unit which are respectively in signal connection with track relays associated with the interlocking system and the station train control system; the trackside simulation system changes, via the first interface unit and the second interface unit, a status of a trackside relay in the real system corresponding to one or more virtual track sections occupied by the simulation train; and the interlocking system and the station train control system set one or more corresponding track sections to be occupied or cleared in the real system based on a collected status of a corresponding track relay, thereby achieving operation of the simulation train in the real system.

Optionally, the interface unit further includes a software interface unit; the software interface unit includes a third interface unit and a fourth interface unit which are respectively in signal connection with interfaces in the interlocking system and the station train control system that are reserved for a maintenance system; and the trackside simulation system acquires the train operation information of the one or more real trains via one or more of the third interface unit and the fourth interface unit.

Optionally, the software interface unit further includes a fifth interface unit and a sixth interface unit; the fifth interface unit is in signal connection with an interface of the station CTC that is reserved for the maintenance system; and the sixth interface unit is in signal connection with the central CTC, and the trackside simulation system acquires the train operation information of the one or more real trains via one or more of the fifth interface unit and the sixth interface unit.

Optionally, in the CTCS level 3 or higher level real signal system the central train control system further includes a seventh interface in communication connection with the simulation on-board train control system, and the simulation on-board train control system sends the train operation information and stopping accuracy and standstill information of the simulation train to the central train control system via the seventh interface; and the central train control system sends the movement authority to the simulation on-board train control system via the seventh interface.

The present disclosure further provides a method for interactive operation of a real train and a simulation train, implemented by the system for interactive operation of a real train and a simulation train of the present disclosure, including steps of:
S1, acquiring, by a trackside simulation system, train operation information of one or more real trains via a software interface unit of an interface unit, and displaying, based on the train operation information of the one or more real trains, one or more simulation track sections corresponding to one or more locations where the one or more real trains is located as occupied;
S2, verifying, by the trackside simulation system, whether an addition location of a simulation train is legal, and if so, displaying a status of one or more simulation track sections corresponding to the addition location of the simulation train as occupied in the trackside simulation system; and displaying one or more real track sections corresponding to the one or more simulation track sections as occupied in a real system via a hardware interface unit of the interface unit;
S3, handling a route for the simulation train in the real system, clearing a corresponding signal, and synchronizing a route status and a cleared signal status to the simulation system;
S4, starting the simulation train in the simulation system, outputting, by the trackside simulation system via the hardware interface unit based on an occupied or cleared status of the simulation track section of the simulation train, an occupied or cleared signal of a corresponding real track section to the real system, and updating an occupied or cleared status of the corresponding real track section in the real system;
S5, when the one or more real trains has a departure condition, handling a departure route for the one or more real trains in the real system and clearing a corresponding signal, starting the one or more real trains for tracking operation with the one or more simulation trains, and during the tracking operation of the one or more real trains and the one or more simulation trains, synchronizing in real time the train operation information of the one or more real trains and the one or more simulation trains in a real signal system and a trackside signal system; and
S6, when the tracking operation ends, deleting the one or more simulation trains in the simulation system, and updating the status of the real track section occupied by the one or more simulation trains as cleared in the real system.

Optionally, in step S2, when the addition location of the one or more simulation trains does not conflict with the location of the one or more real trains, the addition location of the one or more simulation trains is legal; and in step S5, when the one or more real trains does not conflict with the one or more simulation trains in location, the one or more real trains has the departure condition.

Optionally, the displaying one or more real track sections corresponding to the one or more simulation track sections as occupied in a real system via a hardware interface unit in step S2 includes:
S21, sending, by the trackside simulation system via the hardware interface unit, a track section occupied signal of the simulation train to a corresponding trackside relay in an interlocking system and a station train control system, and enabling a corresponding trackside relay in the real system to operate; and
S22, setting, by the interlocking system and the station train control system based on a recovery signal of the corresponding trackside relay, a status of the real track section corresponding to the addition location of the simulation train as occupied in the real system.

Compared with the prior art, the present disclosure has the following beneficial effects:
1) The system for interactive operation of real train and simulation train of the present disclosure has the highly simulated trackside simulation system and simulation train, the simulation train can simulate the operation of the real train in the trackside simulation system, and all the movement authority, route handling and signal clearing of the simulation train are the same as those of the real train. The present disclosure further achieves the real-time interaction of train operation information between the real train and the simulation train via an interface unit in a real system and a simulation system, and achieves automatic and synchronous updating of the cleared or occupied status and signal status of a real track section corresponding to the location where the simulation train is located in the real system and achieves automatic and synchronous updating of the cleared or occupied status and signal status of a simulation track section corresponding to the location where the real train is located in the simulation system, so that the real train and the simulation train can operate simultaneously in the real system and the simulation system. The present disclosure meets the requirements of a pilot line for carrying out a multi-train tracking test on trains, which can help to test the safety performance of a new train operation control system, with true and reliable test results.
2) In the present disclosure, the number of simulation trains and real trains is limited only by the condition and capacity of a real train operation line, enabling the tracking operation of a larger number of simulation trains and real trains in the simulation system and the real system; moreover, the multi-train tracking test is carried out without relying on manual operations, test data are collected in real time from the real system and the simulation system, and the test results of multi-train tracking are more true and reliable, so the test results have very good practical value.
3) The present disclosure is applicable to real signal systems of different systems and levels, and can achieve the information interaction between the simulation system and the real system without modifying any system software in a real signal system. There is no adverse effect on the normal operation of the real system.

### BRIEF DESCRIPTION OF THE DRAWINGS

To describe the technical solution of the present disclosure more clearly, the drawings needed in the description will be introduced briefly below. It is apparent that the drawings described below are one embodiment of the present disclosure, and those of ordinary skill in the art further can obtain other drawings according to those drawings without paying out any creative effort:

FIG. 1 is a schematic structural diagram of a system for interactive operation of a real train and a simulation train of the present disclosure;

FIG. 2 is a schematic flow diagram of interactive operation of a real train and a simulation train of the present disclosure;

FIG. 3 is a schematic structural diagram of a system for interactive operation of a real train and a simulation train in Embodiment 1 of the present disclosure.

### DETAILED DESCRIPTION OF THE EMBODIMENTS

The technical solutions in the embodiments of the present disclosure will be clearly and intactly described below in conjunction with the drawings in the embodiments of the present disclosure. It is apparent that the embodiments described are merely a part of the embodiments of the present disclosure, rather than all of them. All other embodiments obtained by those of ordinary skill in the art based on the embodiments of the present disclosure without creative effort shall fall within the scope of protection of the present disclosure.

It is to be understood that the terminology “include/including”, when used in the present specification and appended claims, denotes the presence of the described features, integers, steps, operations, elements, and/or components, but does not preclude the presence or addition of one or more other features, integers, steps, operations, elements, components, and/or groups thereof.

It is to be further understood that the terminology used in the specification of the present application is solely for the purpose of describing particular embodiments and is not intended to limit the present application. As used in the specification and appended claims of the present application, the singular forms “a/an”, “one”, and “the” are intended to include plural forms unless the context expressly dictates otherwise.

It is to be further understood that the term “and/or” as used in the specification and appended claims of the present application refers to any combination of one or more of the associated listed items and all possible combinations thereof, and includes such combinations.

As used in the specification and the appended claims, the term “if” may be interpreted, depending on the context, as “when”, “once”, “in response to determining”, or “in response to detecting”. Similarly, the phrase “if it is determined” or “if it is detected that [the described condition or event]” may be interpreted, depending on the context, to mean “once it is determined”, “in response to determining”, “once it is detected that [the described condition or event]”, or “in response to detecting that [the described condition or event]”.

In addition, in the description of the present application, the terms “first”, “second”, “third”, and the like are used solely for distinguishing descriptions and are not to be construed as indicating or implying relative importance.

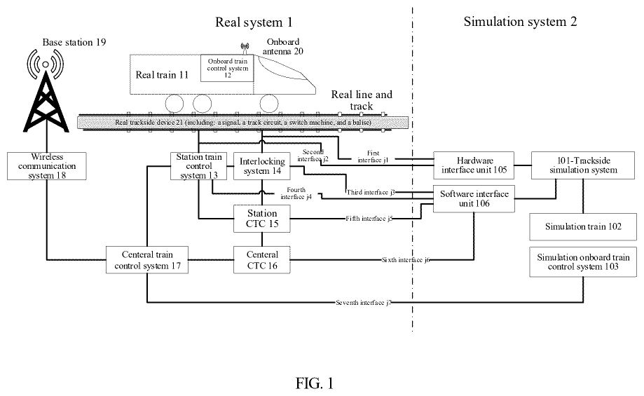

The present disclosure provides a system for interactive operation of real train and simulation train, as shown in FIG. 1, including: a real system 1, a simulation system 2, and an interface unit.

As shown in FIG. 1, the real system 1 includes: one or more real trains 11, one or more real tracks, a real trackside device 21, and a real signal system. The real signal system is used for controlling the real train 11 to normally travel on the real track.

As shown in FIG. 1, the real trackside device 21 includes: any one or more of a signal, a track circuit, a switch machine, a track relay, a balise, and a base station.

As shown in FIG. 1, the real signal system includes: a central centralized traffic control (CTC) 16, a station CTC 15, an interlocking system 14, a station train control system 13, and a central train control system 17. The real signal system in this embodiment is a CTCS level 3 or higher level real signal system. The present disclosure is also applicable to real signal systems at other levels, e.g., at CTCS level 2 or lower level, and is not limited by the level of signal systems.

The central CTC 16 issues traffic schedules for the real train 11 and the simulation train 102 to the station CTC 15. The station CTC 15 automatically generates a route control instruction according to the traffic schedules and sends the route control instruction to the interlocking system 14. The interlocking system 14 controls the real trackside device 21 based on the route control instruction to complete automatic arrangement of routes. The central train control system 17 implements, based on a temporary speed restriction command sent by the central CTC 16, digital coding on the track circuit, and generation and selection of a message of the balise. A station train control center sends the message to the balise, and the message includes: receiving route information, temporary speed restriction information, and home signal degraded indication.

As shown in FIG. 1, the real train 11 is provided with an on-board train control system 12, and the on-board train control system 12 includes: an automatic train protection (ATP), a peripheral sensor (not shown), and a communication device (not shown). The real train 11 receives, via the peripheral sensor, the message sent by the balise. Some real trains 11 are further provided with an automatic train operation (ATO).

As shown in FIG. 1, the on-board train control system 12 is in wireless communication with a base station 19 via an on-board antenna 20 so as to receive the message, and the on-board train control system 12 obtains a movement authority based on the received message. The central train control system 17 is further connected to the base station 19 via a wireless communication system 18. The on-board train control system 12 sends corresponding train operation information of the real train 11 to the central train control system 17 via the base station 19. The train operation information includes: location information, route information, an occupied or cleared status of a track section, a signal display status, etc.

The simulation system 2 is implemented by software, and includes: one or more simulation trains 102 and a trackside simulation system 101. The trackside simulation system 101 has one or more simulation stations, one or more simulation tracks, and one or more simulation trackside devices corresponding to one or more real stations, one or more real tracks, and one or more real trackside signal devices 21 of the real system 1. The simulation train 102 operates on the simulation track. The simulation train 102 is provided with a simulation on-board train control system 103, and the simulation on-board train control system 103 has same functions (processing temporary speed restriction, balise message, track code sending, etc.) as the on-board train control system 12.

In a CTCS level 2 or lower level real signal system, the movement authority of the real train 11 is from track circuit code sending and/or signal indication in the real system 1, and the track circuit code sending and/or the signal indication is synchronized to the trackside simulation system 101 for performing movement authority on the simulation train 102. In a CTCS level 3 or higher level real signal system, the movement authority of both the simulation train 102 and the real train 11 is from the central train control system 17 in the real system 1.

The interface unit is used for synchronizing and updating the train operation information of the real train 11 and the simulation train 102 in real time in the real signal system and a trackside signal system, to achieve the interactive operation of the real train 11 and the simulation train 102 in the real system 1 and the simulation system 2. It needs to be noted that the simulation train 102 operating in the real system 1 in the present disclosure refers to: changing an occupied or cleared status and a signal status of a corresponding real track section in the real system 1 based on the train operation information of the simulation train 102 in the simulation system 2. The real train 11 operating in the simulation system 2 in the present disclosure refers to:
changing an occupied or cleared status and a signal status of a corresponding simulation track section in the simulation system 2 based on the train operation information of the real train 11 in the real system 1. The interactive operation of the present disclosure refers to: achieving the simultaneous operation of the real train 11 and the simulation train 102 in the real system 1 and the simulation system 2 in a case where the real system 1 and the simulation system 2 interact with the train operation information of the real train 11 and the simulation train 102 in real time via the interface unit.

The interface unit includes a hardware interface unit 105 and a software interface unit 106.

As shown in FIG. 1, the hardware interface unit 105 includes a first interface unit and a second interface unit which are respectively in signal connection with track relays associated with the interlocking system 14 and the station train control system 13. The trackside simulation system 101 changes, via the first interface unit and the second interface unit, a status of a trackside relay (in the real system 1) corresponding to one or more simulation track sections occupied by the simulation train 102; and the interlocking system 14 and the station train control system 13 set a corresponding track section to be occupied or cleared in the real system 1 based on a collected status of a corresponding track relay (in the real system 1), thereby achieving operation of the simulation train 102 in the real system 1. The occupancy status of track sections during the operation of the simulation train 102 in the simulation system 2 can be reflected in real time to the real system 1 via the hardware interface unit 105.

The software interface unit 106 includes: third to seventh interface units.

As shown in FIG. 1, the third interface unit and the fourth interface unit are respectively in signal connection with interfaces in the interlocking system 14 and the station train control system 13 that are reserved for a maintenance system. The fifth interface unit is in signal connection with an interface of the station CTC 15 that is reserved for the maintenance system. The sixth interface unit is in signal connection with the central CTC 16. The trackside simulation system 101 acquires the train operation information of the real train 11 via any one or more of the third interface unit to the sixth interface unit.

In the CTCS level 3 or higher level real signal system, the central train control system 17 further includes a seventh interface in communication connection with the simulation on-board train control system 103, and the simulation on-board train control system 103 sends the train operation information and stopping accuracy and standstill information of the simulation train 102 to the central train control system 17 via the seventh interface. The central train control system 17 sends the movement authority to the simulation on-board train control system 103 via the seventh interface. In the present disclosure, the train operation situation of the simulation train 102 is reflected into the real system 1 via any one or more of the hardware interface unit 105 and the seventh interface. In the present disclosure, the real on-board train control system 12 and the central train control system 17, as well as the simulation on-board train control system 103 and the central train control system 17, have identical communication protocols.

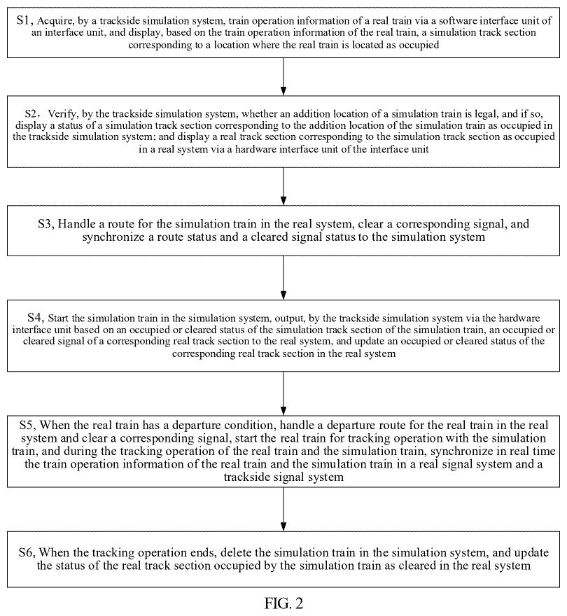

The present disclosure further provides a method for interactive operation of real train and simulation train, implemented by the system for interactive operation of real train and simulation train of the present disclosure, as shown in FIG. 2, including steps of:
S1, acquiring, by a trackside simulation system 101, train operation information of one or more real trains 11 via a software interface unit 106 of an interface unit, and displaying, based on the train operation information of the real train 11, one or more simulation track sections corresponding to a location where the real train 11 is located as occupied;
S2, verifying, by the trackside simulation system 101, whether an addition location of one or more simulation trains 102 is legal, and if so (when the addition location of the simulation train 102 does not conflict with the location of the real train 11), displaying a status of one or more simulation track sections corresponding to the addition location of the simulation train 102 as occupied in the trackside simulation system 101 of the interface unit; and
   displaying the real track section corresponding to the simulation track section as occupied in a real system 1 via a hardware interface unit 105, including:
S21, sending, by the trackside simulation system 101 via the hardware interface unit 105, a track section occupied signal of the simulation train 102 to a corresponding trackside relay in an interlocking system 14 and a station train control system 13, and enabling a corresponding trackside relay in the real system 1 to operate; and
S22, setting, by the interlocking system 14 and the station train control system 13 based on a recovery signal of the corresponding trackside relay, a status of the real track section corresponding to the addition location of the simulation train 102 as occupied in the real system 1.
S3, handling a route for the simulation train 102 in the real system 1, clearing a corresponding signal, and synchronizing a route status and a cleared signal status to the simulation system 2;
S4, starting the simulation train 102 in the simulation system 2, outputting, by the trackside simulation system 101 via the hardware interface unit 105 based on an occupied or cleared status of the simulation track section of the simulation train 102, an occupied or cleared signal of a corresponding real track section to the real system 1, and updating an occupied or cleared status of the corresponding real track section in the real system 1;
S5, when the real train 11 has a departure condition (the location of the real train 11 does not conflict with the location of the simulation train 102), handling a departure route for the real train 11 in the real system 1 and clearing a corresponding signal, starting the real train 11 for tracking operation with the simulation train, and during the tracking operation of the real train 11 and the simulation train 102, synchronizing in real time the train operation information of the real train 11 and the simulation train 102 in a real signal system and a trackside signal system; and
S6, when the tracking operation ends, deleting the simulation train 102 in the simulation system 2, and updating the status of the real track section occupied by the simulation train 102 as cleared in the real system 1.

### Embodiment 1

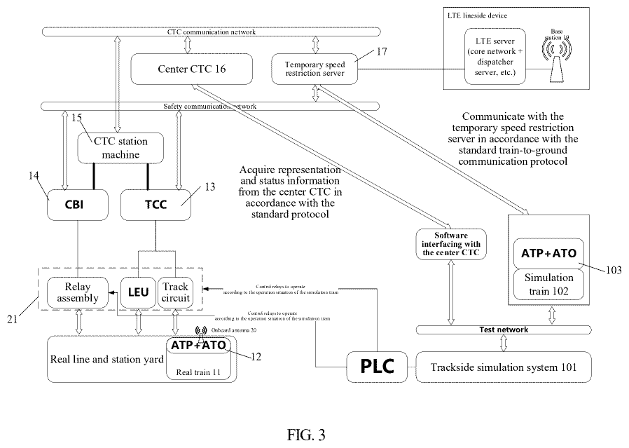

In this embodiment, as shown in FIG. 3, a real system 1 of CTCS-2+ATO (a real on-board train control system 12 is ATO, and a real signal system is a CTCS level 2 signal system) is used. In this embodiment, a central train control system 17 uses a temporary speed restriction server, a station CTC 15 uses a CTC station machine system, an interlocking system 14 uses computer based interlocking (CBI), and a station train control system 13 uses a station train control center (TCC). As shown in FIG. 3, a real trackside signal device 21 in this embodiment includes a CBI-associated relay assembly, a lineside electronic unit (LEU, which is in wireless communication with a balise), a track circuit, etc.

In this embodiment, an on-board train control system 12 of one or more real trains 11 includes ATP+ATO, correspondingly, a simulation on-board train control system 103 of one or more simulation trains 102 also includes simulated ATP and ATO (corresponding to a module 103 in FIG. 1).

In this embodiment, a hardware interface unit 105 is implemented by PLC, which controls the status of a track relay of a corresponding real track section, achieving the output of occupied and cleared signals of the corresponding real track section. The interlocking system 14 and the station train control system 13 can collect the status of the track relay and set the corresponding real track section to be occupied or cleared in the real system 1, achieving the operation of the simulation train 102 in the real system 1 (via interface 1 and interface 2).

A software interface unit 106 is implemented by software interfacing with a central CTC, which is in communication with the central CTC via a standard open interface (i.e., interface 6 in FIG. 1), to synchronize the train operation status of the real system 1 to the trackside simulation.

The simulation train 102 is in wire communication with the temporary speed restriction server to which a location report and stopping accuracy, standstill information, etc. of the simulation train 102 are sent.

The present disclosure meets the requirements of a pilot line for carrying out a multi-train tracking test on trains, which can help to test the safety performance of a new train operation control system, with true and reliable test results. The number of simulation trains 102 and real trains 11 is limited only by the condition and capacity of the real train operation line, enabling the operation of a larger number of simulation trains 102 and real trains 11 in the simulation system 2 and the real system 1, so the results of the multi-train tracking test are more true and reliable, and the test results have very good practical value. The present disclosure is applicable to real signal systems of different systems and levels and can achieve the information interaction between the simulation system 2 and the real system 1 without modifying any system software in a real signal system.

It is to be understood that the numerical order of the steps in the above embodiments does not imply an execution sequence, and the execution sequence of each process is to be determined by its function and inherent logic and is not to be construed as limiting the implementation of the embodiments of the present application.

The above descriptions are only specific implementations of the present disclosure, but the scope of protection of the present disclosure is not limited thereto. Any skilled person familiar with this technical field can readily conceive of various equivalent modifications or substitutions within the technical scope disclosed by the present disclosure. All such modifications or substitutions shall fall within the scope of protection of the present disclosure. Therefore, the scope of protection of the present disclosure shall be determined by the scope of protection of the claims.

1. A system for interactive operation of a real train and a simulation train, comprising:
a real system which comprises: one or more real trains, one or more real tracks, a real trackside device, and a real signal system; and the real signal system is used for controlling the one or more real trains to normally travel on the one or more real tracks;
a simulation system which is implemented by software, and comprises: one or more simulation trains and a trackside simulation system; the trackside simulation system has one or more simulation stations, one or more simulation tracks, and a simulation trackside device corresponding to the real system; and the one or more simulation trains operates on the one or more simulation tracks; and
an interface unit which synchronizes train operation information of the one or more real trains and the one or more simulation trains in real time in the real signal system and a trackside signal system, and the train operation information comprises: location information, route information, an occupied or cleared status of one or more track sections, and a signal display status; the trackside simulation system controls, based on the location information of the one or more real trains, the one or more simulation trains to be added on the one or more simulation tracks; and the real signal system calculates and sends a corresponding movement authority for the one or more real trains and the one or more simulation trains, to achieve the interactive operation of the one or more real trains and the one or more simulation trains in the real system and the simulation system.

2. The system for interactive operation of a real train and a simulation train according to claim 1, wherein the real trackside device comprises any one or more of: a signal, a track circuit, an axle counter, a switch machine, and a balise.

3. The system for interactive operation of a real train and a simulation train according to claim 2, wherein the real signal system comprises:
a central centralized traffic control (CTC), a station CTC, an interlocking system, a station train control system, and a central train control system;
the central CTC issues traffic schedules of the one or more real trains and the one or more simulation trains to the station CTC;
the station CTC automatically generates a route control instruction according to the traffic schedules and sends the route control instruction to the interlocking system;
the interlocking system controls the real trackside device based on the route control instruction to complete automatic arrangement of routes;
the central train control system implements, based on a temporary speed restriction command sent by the central CTC, digital coding on the track circuit and generation and selection of a message of the balise; and
a station train control center is used for sending the message to the balise, wherein the message comprises: receiving route information, temporary speed restriction information, and home signal degraded indication.

4. The system for interactive operation of a real train and a simulation train according to claim 1, wherein:
the one or more real trains is provided with an on-board train control system which comprises an automatic train protection and/or an automatic train operation; and
the one or more simulation trains is provided with a simulation on-board train control system which has same functions as the on-board train control system.

5. The system for interactive operation of a real train and a simulation train according to claim 4, wherein the real trackside device further comprises a wireless communication system which is in wireless signal connection between the central train control system and the on-board train control system and is used for wirelessly sending the message to the on-board train control system.

6. The system for interactive operation of a real train and a simulation train according to claim 3, wherein in a CTCS level 2 or lower real signal system, the movement authority of the one or more real trains is from track circuit code sending and/or signal indication in the real system, and the track circuit code sending and/or the signal indication is synchronized to the trackside simulation system for performing movement authority on the one or more simulation trains; and in a CTCS level 3 or higher level real signal system, the movement authority of both the one or more simulation trains and the one or more real trains is from the central train control system in the real system.

7. The system for interactive operation of a real train and a simulation train according to claim 3, wherein the interface unit comprises a hardware interface unit; the hardware interface unit comprises a first interface unit and a second interface unit which are respectively in signal connection with track relays associated with the interlocking system and the station train control system; the trackside simulation system changes, via the first interface unit and the second interface unit, a status of a trackside relay in the real system corresponding to one or more virtual track sections occupied by the simulation train; and the interlocking system and the station train control system set one or more corresponding track sections to be occupied or cleared in the real system based on a collected status of a corresponding track relay, thereby achieving operation of the simulation train in the real system.

8. The system for interactive operation of a real train and a simulation train according to claim 3, wherein the interface unit further comprises a software interface unit; the software interface unit comprises a third interface unit and a fourth interface unit which are respectively in signal connection with interfaces in the interlocking system and the station train control system that are reserved for a maintenance system; and the trackside simulation system acquires the train operation information of the one or more real trains via one or more of the third interface unit and the fourth interface unit.

9. The system for interactive operation of a real train and a simulation train according to claim 8, wherein the software interface unit further comprises a fifth interface unit and a sixth interface unit; the fifth interface unit is in signal connection with an interface of the station CTC that is reserved for the maintenance system; and the sixth interface unit is in signal connection with the central CTC, and the trackside simulation system acquires the train operation information of the one or more real trains via one or more of the fifth interface unit and the sixth interface unit.

10. The system for interactive operation of a real train and a simulation train according to claim 6, wherein in the CTCS level 3 or higher level real signal system, the central train control system further comprises a seventh interface in communication connection with the simulation on-board train control system, and the simulation on-board train control system sends the train operation information and stopping accuracy and standstill information of the simulation train to the central train control system via the seventh interface; and the central train control system sends the movement authority to the simulation on-board train control system via the seventh interface.

11. A method for interactive operation of a real train and a simulation train, implemented by the system for interactive operation of a real train and a simulation train according to claim 1, comprising the steps of:
S1, acquiring, by a trackside simulation system, train operation information of one or more real trains via a software interface unit of an interface unit, and displaying, based on the train operation information of the one or more real trains, one or more simulation track sections corresponding to one or more locations where the one or more real trains is located as occupied;
S2, verifying, by the trackside simulation system, whether an addition location of a simulation train is legal, and if so, displaying a status of one or more simulation track sections corresponding to the addition location of the simulation train as occupied in the trackside simulation system; and displaying one or more real track sections corresponding to the one or more simulation track sections as occupied in a real system via a hardware interface unit of the interface unit;
S3, handling a route for the simulation train in the real system, clearing a corresponding signal, and synchronizing a route status and a cleared signal status to the simulation system;
S4, starting the simulation train in the simulation system, outputting, by the trackside simulation system via the hardware interface unit based on an occupied or cleared status of the simulation track section of the simulation train, an occupied or cleared signal of a corresponding real track section to the real system, and updating an occupied or cleared status of the corresponding real track section in the real system;
S5, when the one or more real trains has a departure condition, handling a departure route for the one or more real trains in the real system and clearing a corresponding signal, starting the one or more real trains for tracking operation with the one or more simulation trains, and during the tracking operation of the one or more real trains and the one or more simulation trains, synchronizing in real time the train operation information of the one or more real trains and the one or more simulation trains in a real signal system and a trackside signal system; and
S6, when the tracking operation ends, deleting the one or more simulation trains in the simulation system, and updating the status of the real track section occupied by the one or more simulation train as cleared in the real system.

12. The method for interactive operation of a real train and a simulation train according to claim 11, wherein in step S2, when the addition location of the one or more simulation trains does not conflict with the location of the one or more real trains, the addition location of the one or more simulation trains is legal; and in step S5, when the one or more real trains does not conflict with the one or more simulation trains in location, the one or more real trains has the departure condition.

13. The method for interactive operation of a real train and a simulation train according to claim 11, wherein the displaying one or more real track sections corresponding to the one or more simulation track sections as occupied in a real system via a hardware interface unit in step S2 comprises the steps of:
S21, sending, by the trackside simulation system via the hardware interface unit, a track section occupied signal of the simulation train to a corresponding trackside relay in an interlocking system and a station train control system, and enabling a corresponding trackside relay in the real system to operate; and
S22, setting, by the interlocking system and the station train control system based on a recovery signal of the corresponding trackside relay, a status of the real track section corresponding to the addition location of the simulation train as occupied in the real system.
